(19) United States
(12) Patent Application Publication
(10) Pub. No.: US 2023/0415391 A1
(43) Pub. Date: Dec. 28, 2023

(54) PLASTICIZING UNIT AND/OR AN INJECTION UNIT FOR A MOLDING MACHINE

(71) Applicant: ENGEL AUSTRIA GmbH, Schwertberg (AT)

(72) Inventors: Guenther KLAMMER, Aschbach Markt (AT); Klaus FELLNER, Steyr (AT); Lukas GUGLER, St. Peter (AT)

(21) Appl. No.: 18/143,814

(22) Filed: May 5, 2023

(30) Foreign Application Priority Data
Jun. 27, 2022 (AT) A 50464/2022

(51) Int. Cl. B29C 45/63; B29C 45/50; B29C 45/60

(52) U.S. Cl. CPC B29C 45/63; B29C 45/50; B29C 45/60; B29C 2045/605

(57) ABSTRACT

A plasticizing unit and/or injection unit for a molding machine with an injection cylinder for plasticized material, at least one degassing opening, and a degassing device in flow connection with the at least one degassing opening for releasing and discharging undesired gases from the plasticized material. The degassing device has a flow element, in flow connection with the at least one degassing opening, which is formed to generate a negative pressure by the Venturi effect at the degassing opening, and/or the degassing device has a filter device, in flow connection with the at least one degassing opening, for filtering gases being released.

### BACKGROUND OF THE INVENTION

The present invention relates to a plasticizing unit and/or an injection unit for a molding machine, as well as a molding machine with such a plasticizing unit and/or injection unit.

Molding machines can include injection-molding machines, transfer-molding machines, presses and the like. Molding machines in which the plasticized material is supplied to an open mold are also entirely conceivable.

The state of the art is to be outlined below with reference to an injection-molding machine. This applies analogously to molding machines in general.

Generic plasticizing units and/or injection units for a molding machine comprise an injection cylinder for plasticized material, at least one degassing opening and a degassing device, in flow connection with the at least one degassing opening, for releasing and discharging undesired gases from the plasticized material.

Such devices are in most cases used in compounding or recycling applications. In corresponding applications, a plastic to be recycled or to be utilized (generally referred to as “a material to be plasticized” in the following) is first plasticized via a plasticizing unit.

Corresponding plasticizing units are used in injection-molding machines to plasticize a material to be plasticized through a rotational movement of a plasticizing screw, wherein the material to be plasticized is plasticized due to the shear energy, shear heat and optionally externally supplied heat energy.

Corresponding plasticizing units are in most cases designed as a single- or multi-screw extruder (also referred to as a “single- or multi-shaft extruder”).

After the plasticizing, either this plasticized material is supplied to a separate injection unit of an injection-molding machine, in order to bring the plasticized (recycled) material into a new shape and thus to supply it for a new intended use, for example by means of an injection plunger, or the plasticizing screw is itself formed axially displaceable and can itself be used for the injection of the plasticized material (combined plasticizing and injection unit).

It is known from the state of the art to process contaminated plastics as material to be plasticized. These plastics can be for example recyclates, material to be ground and/or agglomerates, which are used for example in a recycling or compounding application.

This topic is becoming ever more important, wherein through the recycling of materials to be plasticized (for example thermoplastics) they can be supplied for a new use or a new area of application and thus a striking advantage is created with respect to environmental friendliness.

Of course, other possibilities for further processing are also possible. Thus, the plasticized material can be supplied for example to a continuous casting, a transfer-molding machine, a press, a semi-finished product production or the like and further processed using these.

However, a problem in the compounding or recycling application is that after the plasticizing the plasticized material still carries undesired gases and inclusions in gas form, which leads to a lower component quality in the further processing. Such undesired gases can be foreign substances, such as residues of washing solutions or additives.

It is known from the state of the art to carry out a degassing of the plasticized material in order to homogenize the molten material and/or in order to prevent pore formations in the further processing.

Thus, it is known for example to guide the plasticized material through perforated plates, which split the strand of the plasticized material and thus release inclusions (gas inclusions) in the strand of the plasticized material towards the environment, whereby the gases can be discharged.

The “slicing” of a strand of plasticized material by protrusions is also known through the state of the art, whereby inclusions in the strand of the plasticized material can again be extracted and thus discharged from the plasticized material (as shown for example by GB 442968 A).

However, a disadvantage of such methods is that the degassing is implemented under atmospheric pressures, wherein particles present in the plasticized material which have a gas pressure lower than the atmospheric pressure remain in the molten material.

Furthermore, methods are also known in which a vacuum system is installed for the degassing, with the result that particles and gases can be released out of the plasticized material via a generated vacuum.

However, a disadvantage of this is that a very great effort is to be made to generate a vacuum, wherein in the region of the degassing a corresponding pressure chamber for establishing a negative pressure must be sealed and in most cases very expensive equipment for generating a vacuum has to be budgeted for.

A further disadvantage is that vacuum systems have a very high energy requirement, whereby the compounding or recycling application for plastics and materials to be plasticized proves to be unattractive for a user again on the grounds of cost and energy.

It has likewise proved to be disadvantageous in known embodiment variants of the state of the art that the gases which are released out of the plasticized material during the degassing often contain noxious or toxic substances, whereby a user and/or people in the surroundings is/are exposed to an increased health risk above all in the case of degassing under atmospheric pressure.

### SUMMARY OF THE INVENTION

The object of the present invention is therefore to provide a plasticizing unit and/or injection unit for a molding machine in which the above-listed disadvantages of the state of the art are at least in part improved and/or a better and/or more efficient degassing of a plasticized material can be ensured and/or a more energy-efficient method for the degassing is made possible and/or a more energy-efficient recycling can be implemented and/or a more environmentally friendly degassing can be ensured and/or the degassing represents a lower health risk for users and people in the surroundings.

According to the invention, the plasticizing unit and/or injection unit for a molding machine has an injection cylinder for plasticized material, at least one degassing opening and a degassing device, in flow connection with the at least one degassing opening, for releasing and discharging undesired gases from the plasticized material. Furthermore:
the degassing device has a flow element, in flow connection with the at least one degassing opening, which is formed to generate a negative pressure by means of the Venturi effect at the degassing opening, and/or
the degassing device has a filter device, in flow connection with the at least one degassing opening, for filtering gases being released.

Through the use of a flow element which functions using the Venturi effect, a negative pressure can be generated at the degassing opening in a simple manner, wherein already existing systems can be utilized on a molding machine of a plasticizing unit and/or an injection unit, such as for example a compressed-air system, whereby gases can be effectively discharged from the plasticized material without having to provide large, complex or expensive devices.

Through the provision of a filter device, the gases forming can be collected during the degassing of the plasticized material before they are released to the environment, with the result that the environmental impact, as well as the impact on the health of a user or people in the surroundings, can be significantly reduced.

The invention furthermore makes it possible to implement a more effective and better degassing of a plasticized material with far more energy-efficient possibilities, whereby the need to establish a negative pressure by means of vacuum devices is dispensed with.

Through the far more energy-saving and more effective, as well as more environmentally friendly, possibility for degassing a plasticized material, the compounding and/or recycling application for plasticized materials becomes more attractive to the user, whereby the environmental aspect can additionally be enhanced by a further expansion of the compounding and/or recycling application.

A plasticizing and/or injection unit according to the invention can have precisely one plasticizing and/or injection screw or also be formed as a twin-screw design or multi-screw design. In the following description, the plasticizing screw (singular) is sometimes mentioned. However, this is to be understood such that analogous embodiments with several plasticizing screws are likewise applicable.

Through its use in already known embodiment variants of the state of the art, as described for example in the introduction to the description, a device according to the invention can be used and subsequently installed.

Molding machines may include injection-molding machines, transfer-molding machines, presses and the like. Molding machines in which the plasticized material is supplied to an open mold are also entirely conceivable.

Preferably, the injection cylinder has an injection nozzle opening, through which the plasticized material can be extracted from the injection cylinder and can be supplied for example to a mold, wherein the injection nozzle opening is formed separate from the at least one degassing opening.

The flow element and/or the filter device is formed as part of a closed flow loop.

Through the formation of a closed flow loop of the flow element and/or the filter device, the environment can additionally be protected from escaping gases, which remain in the closed flow loop.

The advantage is additionally created that the generated flow of the flow element is at least partially preserved by the closed loop, whereby the energy efficiency can additionally be increased.

Preferably, the flow element and/or the filter device is in flow connection with at least one conveyor—preferably a fan, compressor or compactor.

The use of a vacuum device, which supplies the degassed gases of the plasticized material to the filter device, is also entirely conceivable.

The flow element is in flow connection with the filter device.

Preferably, the filter device is connected downstream of the flow element in a flow direction of the forming and/or discharged gas from the plasticized material.

The flow element can be formed to be flowed through by a carrier medium to generate the Venturi effect, preferably with a predetermined pressure and/or a predetermined flow rate, with the result that the gases discharged through the at least one degassing opening are taken up in the carrier medium and/or carried by it.

A negative pressure applied at the degassing opening can be controlled by setting the pressure and/or the flow rate of the carrier medium which flows through the flow element, whereby an area of application can be addressed selectively. Through a setting of the pressure and/or the flow rate of the carrier medium, a plasticized material and dissolved gases in the plasticized material can thus be addressed in a targeted manner.

Preferably, a supply device for a carrier medium is provided, which is formed to bring the gases discharged through the degassing opening into contact with the carrier medium, with the result that the discharged gases are taken up in the carrier medium and/or carried by it.

The carrier medium can serve to take up and/or bind the discharged gases, wherein for example the discharged gases from the carrier medium can be released again in the filter device and the carrier medium can be guided back to take up the discharged gases again, whereas the escaping gases can be taken out of the system for example as hazardous substances.

A wide variety of carriers are suitable as carrier media, such as for example:
steam,
aerosols,
aqueous solutions,
liquid media at low pressure,
compressed air with entrainment of solid powder,
air, preferably compressed air, particularly preferably with dissolved drops of liquid, such as for example oil or water.

The flow element and/or the filter device can be in flow connection with at least one cooling device, which cooling device is formed to cool the gases discharged through the at least one degassing opening, and preferably the carrier medium.

Through the provision of a cooling device, the gases discharged from the plasticized material which have an increased temperature are cooled, whereby a separation of these materials or constituents of them from the carrier medium and/or the air can result, whereby an isolation of the discharged gases or constituents of them can be performed in an effective manner with little energy to be expended.

Preferably, a rotatably mounted, and preferably linearly displaceable, plasticizing screw is arranged in the injection cylinder.

A plasticizing unit can have a plasticizing screw, arranged in the injection cylinder, which is formed to plasticize a material to be plasticized by shearing, shear heat and optionally externally introduced heat.

If, in addition to the rotatable arrangement, the plasticizing screw is also linearly displaceable, the possibility is created of creating a plasticizing and injection unit, wherein a material to be plasticized is first plasticized via the plasticizing screw and conveyed into a front region (the space in front of the screw), wherein the collected, plasticized material can then be extracted from the injection cylinder via an injection nozzle opening by a linear movement of the plasticizing screw in the direction of the space in front of the screw, and optionally supplied to a mold.

An injection unit can preferably have an injection plunger, which is arranged linearly displaceably in the injection cylinder and is formed to push a plasticized material which can be supplied to the injection cylinder out of the injection cylinder, preferably via an injection nozzle opening.

A device according to the invention can be used in a two-stage plasticizing process, wherein a material to be plasticized is first plasticized in a first plasticizing unit and is then supplied to a second plasticizing unit via a molten material line, wherein a further plasticizing and an injection, preferably into a mold, can be performed in the second plasticizing unit.

A distance of the flow element from the at least one degassing opening is smaller than 5 times, preferably 3 times, a reference quantity, and the reference quantity is a screw diameter and/or a characteristic quantity of the degassing opening, wherein the flow element is particularly preferably arranged directly at the at least one degassing opening.

The characteristic quantity is formed by a diameter of an area-equivalent circle of the at least one degassing opening. Thus, for example, in the case of a geometry of the at least one degassing opening deviating from a circle, a surface area of the at least one degassing opening is utilized to form a theoretical diameter (thus a diameter of an area-equivalent circle) and to be used as reference quantity for the calculation of a distance of the flow element from the at least one degassing opening.

A distance between the flow element and the at least one degassing opening is to be measured along the flow path.

The fact that the flow element is particularly preferably arranged “directly” at the at least one degassing opening is to be understood in such a way that the component of the flow element contacts the injection cylinder in the region of the degassing opening.

Preferably, the flow element has a Venturi nozzle.

The filter device can have a separation device, preferably a cyclone separator.

Within the meaning of the present document, by a filtration and/or a filtering of a plasticized material may be meant that foreign substances present in the plasticized material are, preferably mechanically, released, removed, discharged and/or separated at least partially from the plasticized material. This can also thus also include separation methods.

A cyclone separator is often also referred to as a centrifugal separator, cyclone filter, agitator or cyclone dust collector, wherein these inertial separators are used for the separation of gases which have a molecular weight different from the carrier medium or of solid or liquid particles in which gases are dissolved or contained. Centrifugal forces which form due to the generation of an eddy flow are used as separation method.

In preferred embodiments, a cooling device for the filter device, preferably the cyclone separator, can be provided.

### BRIEF DESCRIPTION OF THE DRAWINGS

Further examples, advantages, and details of the invention are represented in the figures and the following description of the figures, in which:

FIG. 1 shows a first embodiment of a plasticizing and injection unit,

FIG. 2 is a detail view of FIG. 1, and

FIG. 3 shows a molding machine with a plasticizing unit and an injection unit.

### DETAILED DESCRIPTION OF THE INVENTION

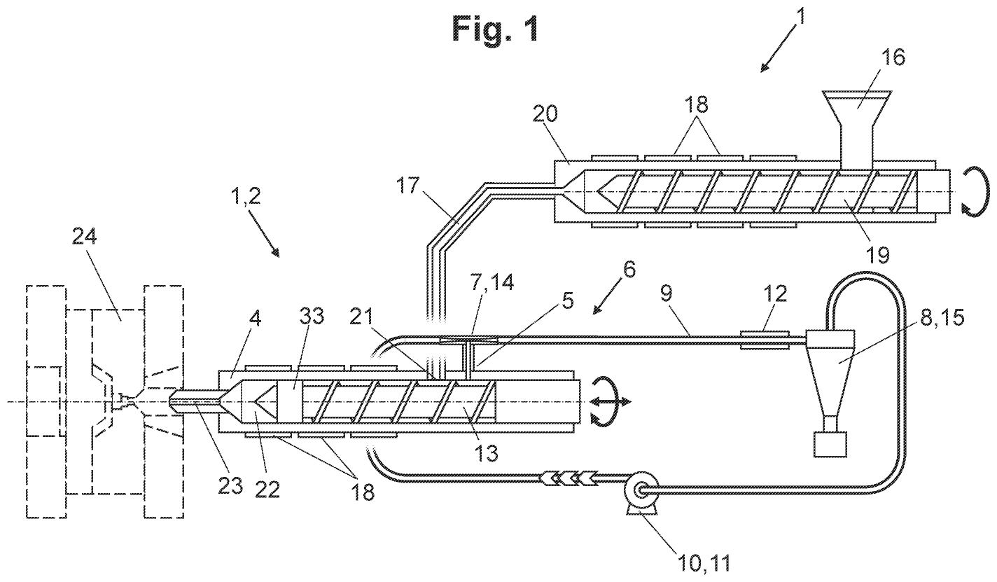

FIG. 1 shows a first embodiment of a plasticizing unit 1 and an injection unit 2, wherein the plasticizing unit 1 and injection unit 2 shown are formed in two stages.

Such a plasticizing unit 1 and injection unit 2 is in most cases used in compounding or recycling applications, wherein a contaminated material to be plasticized is first supplied to a second injection cylinder 20 of a plasticizing unit 1 via the supply device 16.

After the material to be plasticized has been supplied via the supply device 16, the material to be plasticized is plasticized in the second injection cylinder 20 via the rotationally mounted second plasticizing screw 19.

The shearing generated by the plasticizing screw 19, shear heat and the external heat supplied via the heater bands 18 results in the plasticizing, whereby the material to be plasticized is plasticized.

After the plasticizing by the second plasticizing screw 19, the plasticized material is supplied to the injection cylinder 4 via the molten material line 17.

The injection cylinder 4 has a rotationally and linearly movable plasticizing screw 13 (often also referred to as an injection screw), which is mounted in the injection cylinder 4.

The plasticized material from the molten material line 17 entering via the supply opening 21 is further plasticized by this plasticizing screw 13 and conveyed in the direction of the tip of the plasticizing screw 13.

At the tip of the plasticizing screw 13, the plasticized material accumulates in the space in front of the screw 22, wherein the plasticized material is conveyed via the nonreturn valve 33.

This plasticizing process is performed until a desired quantity of plasticized material has accumulated in the space in front of the screw 22.

As soon as the desired quantity of plasticized material has accumulated in the space in front of the screw 22, the plasticizing screw 13 is moved linearly in the direction of the space in front of the screw 22, whereby the nonreturn valve 33 closes and a pressure is exerted on the plasticized material in the space in front of the screw 22.

An injection nozzle opening 23 is opened (actively or passively), with the result that the plasticized material can be supplied to the mold 24 (represented dashed here) via the injection nozzle opening 23 via the pressure exerted on the plasticized material in the space in front of the screw 22 and due to the linear movement of the plasticizing screw 13.

Once the plasticized material supplied into the mold 24 has been pushed out of the injection cylinder 4 by the plasticizing screw 13, this plasticized material cools down in the mold 24 and solidifies to form a molded component, which can then be taken out of the mold 24.

After the injection of the plasticized material from the space in front of the screw 22, the injection nozzle opening 23 is closed again and the plasticizing screw 13 again begins a rotational movement for plasticizing and conveying the plasticized material from the supply opening 21 via the nonreturn valve 33 into the space in front of the screw 22.

The plasticizing unit 1 and injection unit 2 of this embodiment has a degassing device 6.

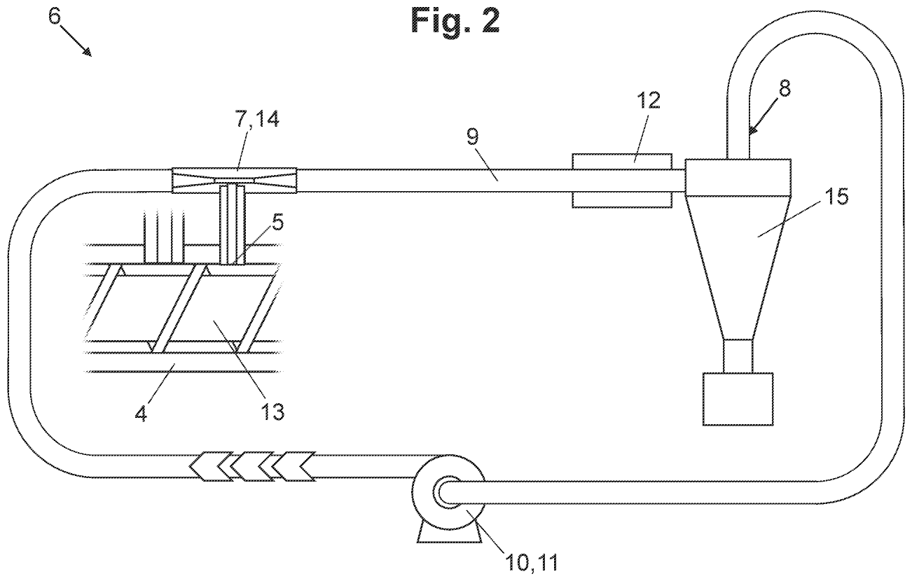

This degassing device 6 is represented in more detail enlarged in FIG. 2.

The degassing device 6 branches off from a degassing opening 5 from the injection cylinder 4, which degassing opening 5 is arranged on a side of the supply opening 21, facing away from the injection nozzle opening 23, in the lateral surface of the injection cylinder 4.

This degassing opening 5 connects the interior of the injection cylinder 4 to the flow element 7, wherein the flow element 7 is formed to generate a negative pressure by means of the Venturi effect at the degassing opening 5.

The flow element 7 of this embodiment is formed as a Venturi nozzle 14, as can be seen in more detail in FIG. 2.

This Venturi nozzle 14 is flowed through by a carrier medium, which is conveyed in the flow loop 9.

In the present embodiment, the carrier medium is steam.

As a result of the flow of the carrier medium through the Venturi nozzle 14, a negative pressure is generated at the degassing opening 5, which has the result that the degassing device 6 releases and discharges undesired gases from the plasticized material in the injection cylinder 4.

The discharged, undesired gases from the plasticized material are mixed with the carrier medium in the Venturi nozzle 14 and supplied to a filter device 8 via the flow loop 9.

This filter device 8 is formed by a cyclone separator 15, whereby the undesired gases from the plasticized material can again be separated from the carrier medium and remain behind in the filter device 8, while the carrier medium is supplied back to the flow element 7 (the Venturi nozzle 14) via the conveyor 10, passes through this flow element 7 again, takes up undesired gases and supplies them to the filter device 8 again.

The degassing device 6 furthermore has a cooling device 12, which in this embodiment is connected upstream of the cyclone separator 15 in the flow direction and is formed to cool the carrier medium together with the discharged undesired gas before it reaches the cyclone separator 15.

Due to the cooling of the carrier medium together with the discharged undesired gas by the cooling device 12, the undesired gas subsequently supplied to the cyclone separator 15 is cooled together with the carrier medium, whereby certain constituents—preferably all of the undesired gas—behave unlike the carrier medium due to their material properties, optionally condense, and can thus be separated more effectively from the carrier medium by the cyclone separator 15.

The cyclone separator 15 represented in FIGS. 1 and 2 is to be understood merely as a purely schematic representation.

The carrier medium purged of the undesired gas can then be supplied to the flow loop 9 again, whereas the, preferably condensed, undesired gas or constituents thereof remain in the cyclone separator 15.

It can be provided that the cyclone separator 15 has a discharge device, which is formed to discharge the substances separated from the carrier medium from the cyclone separator 15.

The conveyor 10 of this embodiment has a compactor 11, which moves the carrier medium through the flow loop 9 according to the arrows drawn in and supplies it to the Venturi nozzle 14.

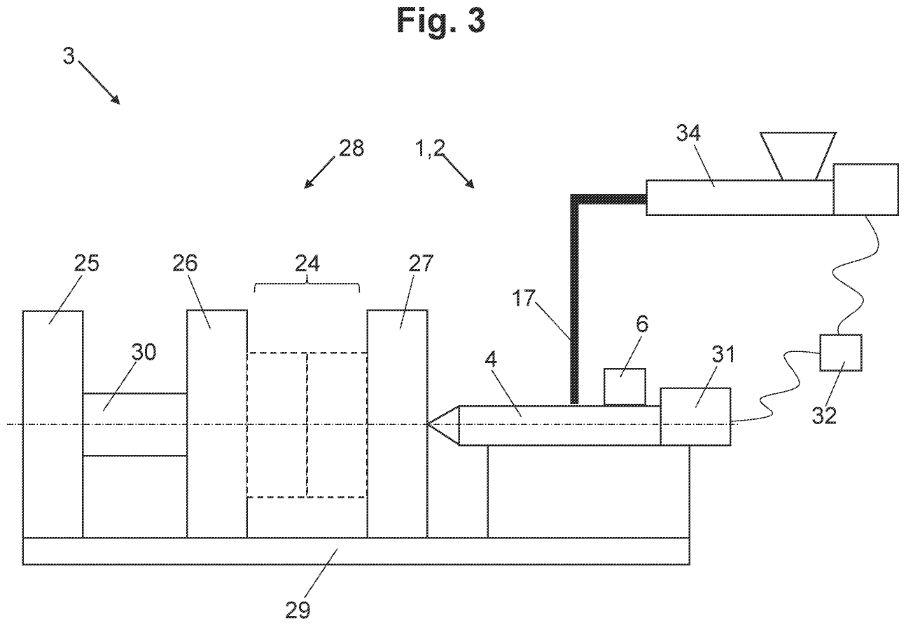

FIG. 3 shows a molding machine 3 with a plasticizing unit 1 and an injection unit 2.

A molding machine 3 is represented schematically in FIG. 3. This molding machine 3 has a plasticizing unit 1 and a clamping unit 28, which are arranged together on a machine frame 28.

The clamping unit 28 has a fixed platen 27, a movable platen 26 and an end plate 25.

In contrast to the horizontal three-plate machine represented, the clamping unit 28 could also be formed as a two-plate machine or as a vertical machine.

The movable platen 26 is movable relative to the machine frame 29 via a drive device 30. Such a drive device 30 can have for example a knuckle joint mechanism.

Mold halves of a mold 24 can be clamped or fitted (represented dashed) on the fixed platen 27 and the movable platen 26.

The mold 24 represented closed in FIG. 3 has at least one cavity. An injection channel, via which a plasticized material can be supplied to the plasticizing unit 1, leads to the cavity.

The plasticizing unit 1 has a continuous plasticizing unit 34, which is formed as a single-screw extruder and via which a recycling material can be supplied.

This continuous plasticizing unit 34 plasticizes the material to be plasticized and further channels the plasticized material via the molten material line into the injection cylinder 4 of the plasticizing unit 1 and injection unit 2.

This injection cylinder can be implemented for example like the embodiment variant represented by FIG. 1.

The plasticized material is supplied to the plasticizing unit 1 and the injection unit 2, wherein the plasticized material is led through an opening of an injection cylinder 4 to the plasticizing screw 13 formed as an injection screw.

The injection unit 2 of this embodiment has an injection cylinder 4 and a plasticizing screw 13 arranged in the injection cylinder 4. This plasticizing screw 13 is rotatable about its longitudinal axis and movable along the longitudinal axis axially in the injection direction.

These movements are initiated via a schematically represented drive unit 31. This drive unit 31 preferably comprises a rotary drive for the rotational movement and a linear drive for the axial injection movement.

The molding machine 3 is in signaling connection with a control or regulating unit 32. Control commands are output to the plasticizing unit 1 and the injection unit 2 by the control or regulating unit 32.

The control or regulating unit 32 can be connected to an operating unit or can be an integral constituent of such an operating unit.

A degassing device arranged on the injection cylinder 4 (which can be designed according to the embodiment of FIGS. 1 and 2) allows a plasticized material loaded with undesired gases (for example a recycled material) to be degassed such that it can be used for example in an injection-molding process known per se for producing molded parts, with the result that the undesired gases have no or at least a significantly reduced influence on the molded parts.

List of Reference Numbers:
1 plasticizing unit
2 injection unit
3 molding machine
4 injection cylinder
5 degassing opening
6 degassing device
7 flow element
8 filter device
9 flow loop
10 conveyor
11 compactor
12 cooling device
13 plasticizing screw
14 Venturi nozzle
15 cyclone separator
16 supply device
17 molten material line
18 heater bands
19 second plasticizing screw
20 second injection cylinder
21 supply opening
22 space in front of the screw
23 injection nozzle opening
24 mold
25 end plate
26 movable platen
27 fixed platen
28 clamping unit
29 machine frame
30 drive device
31 drive unit
32 control or regulating unit
33 nonreturn valve
34 continuous plasticizing unit

1. A plasticizing unit and/or injection unit for a molding machine with an injection cylinder for plasticized material, at least one degassing opening and a degassing device, in flow connection with the at least one degassing opening, for releasing and discharging undesired gases from the plasticized material, wherein:
the degassing device has a flow element, in flow connection with the at least one degassing opening, which is formed to generate a negative pressure by means of the Venturi effect at the degassing opening, and/or
the degassing device has a filter device, in flow connection with the at least one degassing opening, for filtering gases being released.

2. The plasticizing unit and/or injection unit according to claim 1, wherein the flow element and/or the filter device is formed as part of a closed flow loop.

3. The plasticizing unit and/or injection unit according to claim 1, wherein the flow element and/or the filter device is in flow connection with at least one conveyor—preferably a fan, compressor or compactor.

4. The plasticizing unit and/or injection unit according to claim 1, wherein the flow element is in flow connection with the filter device.

5. The plasticizing unit and/or injection unit according to claim 1, wherein the flow element is formed to be flowed through by a carrier medium to generate the Venturi effect, preferably with a predetermined pressure and/or a predetermined flow rate, with the result that the gases discharged through the at least one degassing opening are taken up in the carrier medium and/or carried by it.

6. The plasticizing unit and/or injection unit according to claim 1, wherein at least one supply device for a carrier medium is provided, which is formed to bring the gases discharged through the degassing opening into contact with the carrier medium, with the result that the discharged gases are taken up in the carrier medium and/or carried by it.

7. The plasticizing unit and/or injection unit according to claim 5, wherein the flow element and/or the filter device is in flow connection with at least one cooling device, which cooling device is formed to cool the gases escaping through the at least one degassing opening, and preferably the carrier medium.

8. The plasticizing unit and/or injection unit according to claim 1, wherein a rotatably mounted, and preferably linearly displaceable, plasticizing screw is arranged in the injection cylinder.

9. The plasticizing unit and/or injection unit according to claim 8, wherein the at least one degassing opening is arranged in a region of the plasticizing screw, preferably in a region of the plasticizing zone of the plasticizing screw.

10. The plasticizing unit and/or injection unit according to claim 1, wherein a distance of the flow element from the at least one degassing opening is smaller than 5 times, preferably 3 times, a reference quantity, wherein the reference quantity is a screw diameter and/or a characteristic quantity of the degassing opening, wherein the flow element is particularly preferably arranged directly at the at least one degassing opening.

11. The plasticizing unit and/or injection unit according to claim 1, wherein the flow element has a Venturi nozzle.

12. The plasticizing unit and/or injection unit according to claim 1, wherein the filter device has a separation device, preferably a cyclone separator.

13. A molding machine with a plasticizing unit and/or injection unit according to claim 1.
